(19) United States
(12) Patent Application Publication
(10) Pub. No.: US 2007/0121442 A1
(43) Pub. Date: May 31, 2007

(54) Tracking control method and optical disk drive

(75) Inventors: Kobe Chou, Shindian City (TW); Luke Wen, Shindian City (TW)

Correspondence Address: BIRCH STEWART KOLASCH & BIRCH, PO BOX 747, FALLS CHURCH, VA, 22040-0747, US

(73) Assignee: VIA TECHNOLOGIES, INC.

(21) Appl. No.: 11/386,935

(22) Filed: Mar. 23, 2006

(30) Foreign Application Priority Data
Nov. 29, 2005 (TW) 094141967

(51) Int. Cl. G11B 7/00

(52) U.S. Cl. 369/44.29; 369/44.26; 369/44.28

(57) ABSTRACT

A tracking control method controls an optical disk drive to access an optical disk having a plurality of groove tracks and land tracks, which are alternately interlaced with each other. The tracking control method includes the following steps. First, detecting a track position of the optical disk where the optical disk drive accesses. Then, predicting at least one distance count according to the track position. Finally, generating a switch signal for controlling the optical disk drive to use different accessing powers to access the groove/land tracks according to the distance count. Wherein the track position is located at a current track of the tracks and the distance count represents a length between a start point of the current track and a start point of a following track next to the current track.

### BACKGROUND OF THE INVENTION

1. Field of Invention

The invention relates to a control method for an optical disk drive, and, in particular, to a tracking control method for an optical disk drive.

2. Related Art

In order to store more data in an optical disk, a new generation of optical disk specification uses a laser beam having a shorter wavelength and also changes the track structure of the optical disk.

FIG. 1 is a schematic illustration showing a track structure of an optical disk with the conventional DVD-RAM specification. The tracks of the optical disk include groove tracks and land tracks alternately interlaced to each other. As shown in FIG. 1, an inner ring of the optical disk is a land track, a second ring next to the inner ring is a groove track, and a third ring next to the second ring is a land track. Accordingly, the land and groove tracks are alternately interlaced to form the track structure of the optical disk with the DVD-RAM specification. The alternately interlaced portion between the groove and the land is referred to as a land-groove switch point. When the optical disk drive accesses the optical disk with the DVD-RAM specification, the optical disk drive has to detect the land-groove switch point so as to use different accessing powers for controlling an optical pick-up head to write or read the groove or land tracks. Because the heights of the groove track and the land track are different from each other, the optical pick-up head must be controlled with different accessing powers to correctly write or read the groove or land tracks.

FIG. 2 shows relationships between an emboss signal, a tracking error signal and a switch signal according to the prior art. As shown in FIG. 2, the tracks of the optical disk with the DVD-RAM specification include a plurality of emboss areas corresponding time data pre-grooved on the optical disk. When the optical disk drive accesses the emboss area, an emboss signal is generated. As shown in FIG. 2, the emboss signal is a periodic signal. Generally speaking, when the optical pick-up head accesses the land-groove switch point, the corresponding tracking error signal (TE signal) becomes different. Thus, the prior art detects the tracking error signal to determine the land-groove switch point. As shown in FIG. 2, when the optical pick-up head accesses the land track, the tracking error signal has a sine wave. When the optical pick-up head accesses the groove track, the tracking error signal is a negative sine wave, and the optical disk drive outputs a switch signal for switching between different accessing powers by detecting the variation of the tracking error signal. However, when the optical disk is scratched or the data is not pre-grooved at the beginning, the tracking error signal is not obvious enough. Thus, the variation of the tracking error signal cannot be correctly determined, and the land-groove switch point for the correct switching of the accessing power cannot be correctly found.

In addition, the prior art may use another method to determine the land-groove switch point for the correct switching of the accessing power. FIG. 3 is a schematic illustration showing a physical ID field in a sector according to the prior art. The head of each sector on the track has a physical ID (PID), which includes sector information and a sector number. The sector information includes a reserved column (Reserved), a physical ID number column (Physical ID number), a sector type column (Sector type) and a layer number column (Layer number). The sector type column records the relative position of the sector in this track. For example, the sector type of 4 represents that the sector is the first sector in the track (i.e., the land-groove switch point is located at the start point of this sector). The sector type of 5 represents that the sector is a last sector in this track. The sector type of 6 represents that the sector is the sector prior to the last sector in this track. The sector type of 7 represents that the sector is the sector other than those in the above-mentioned conditions.

The prior art accesses the sector type column of the physical ID of each sector to determine the position of each sector in the track. When the sector type is 5, it represents that the optical pick-up head is reading or writing the sector at the end of this track. That is, the next sector to be accessed by the optical pick-up head pertains to another track, or the start point of the next sector is the land-groove switch point. FIG. 4 shows relationships between the emboss signal, the physical ID and a switch signal according to the prior art. As shown in FIG. 4, the optical disk drive determines the position of each sector in the track by accessing the sector type column of the physical ID. When the sector type of 4 is accessed, a switch signal for switching between different accessing powers is outputted.

However, this prior art has to continuously detect the tracking error signal or access the physical ID field. In other words, if the optical disk has a poor quality or the optical pick-up head is not well controlled when accessing the optical disk, the tracking error signal or the physical ID cannot be accessed or recognized easily. Therefore, the land-groove switch point cannot be correctly determined, and the switching between different accessing powers cannot be made correctly.

Thus, it is an important subject of the invention to provide a tracking control method and an optical disk drive, which can prevent the land-groove switch point from being incorrectly determined such that the optical disk drive can correctly control the optical pick-up head to access the groove track or the land track.

### SUMMARY OF THE INVENTION

The invention discloses a tracking control method for controlling an optical disk drive to access an optical disk, which has a plurality of groove tracks and a plurality of land tracks. The groove tracks and the land tracks are alternately interlaced with each other. The method includes the following steps. First, detecting a track position of the optical disk where the optical disk drive accesses, wherein the track position is located at a current track. Next, predicting at least one distance count, which represents a length between a start point of the current track and a start point of a following track next to the current track, according to the track position of the current track. Finally, generating a switch signal, which controls the optical disk drive to use different accessing powers for accessing the groove tracks and the land tracks, according to the distance count.

The invention also discloses an optical disk drive for accessing an optical disk having a plurality of groove tracks and a plurality of land tracks. The groove tracks and the land tracks are alternately interlaced with each other. The optical disk drive includes a detecting module, a predicting module and a generating module. The detecting module detects a track position of the optical disk where the optical disk drive accesses. The track position is located at a current track. The predicting module predicts a distance count, which represents a length between a start point of the current track and a start point of a following track next to the current track, according to the track position of the current track. The generating module generates a switch signal, which controls the optical disk drive to use different accessing powers for accessing the groove tracks and the land tracks, according to the distance count.

As mentioned above, the tracking control method and the optical disk drive according to the invention detect a track position of the optical disk where the optical disk drive accesses, and then predict at least one distance count according to the track position. Thus, it is possible to prevent the land-groove switch point from being incorrectly determined, such that the optical disk drive can correctly control the optical pick-up head to access the groove tracks or the land tracks.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a track structure of an optical disk with the conventional DVD-RAM specification;

FIG. 2 shows relationships between an emboss signal, a tracking error signal and a switch signal according to the prior art;

FIG. 3 is a schematic illustration showing a physical ID field in a sector according to the prior art;

FIG. 4 shows relationships between the emboss signal, the physical ID and a switch signal according to the prior art;

FIG. 5 is a flow chart showing a tracking control method according to an embodiment of the invention;

FIG. 6 is a schematic illustration showing a track structure of an optical disk in the tracking control method according to the embodiment of the invention;

FIG. 7 is a schematic illustration showing contents of a groove-land switch table in the tracking control method according to the embodiment of the invention; and

FIG. 8 is a block diagram showing an optical disk drive according to an embodiment of the invention.

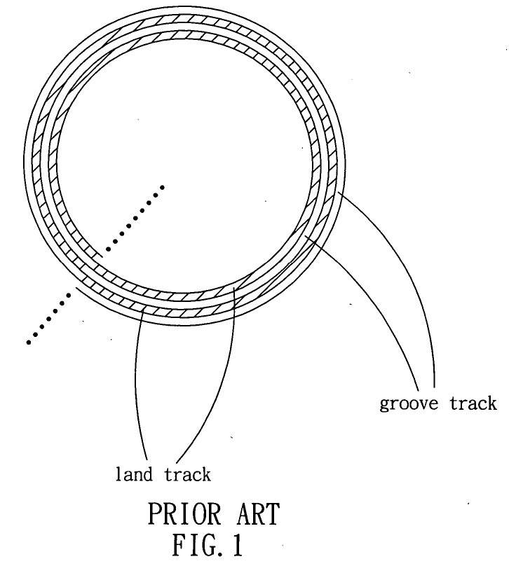

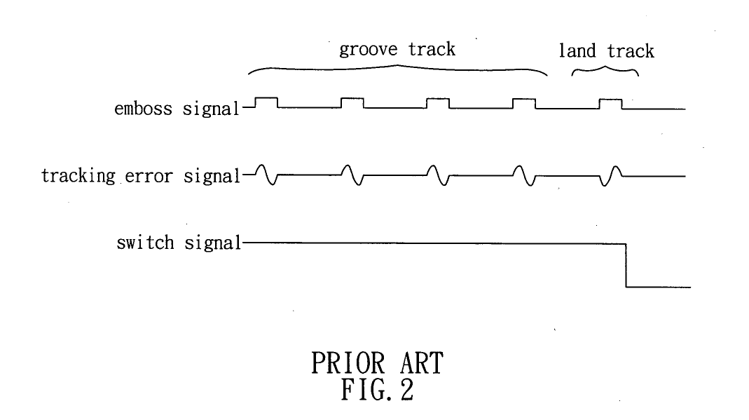

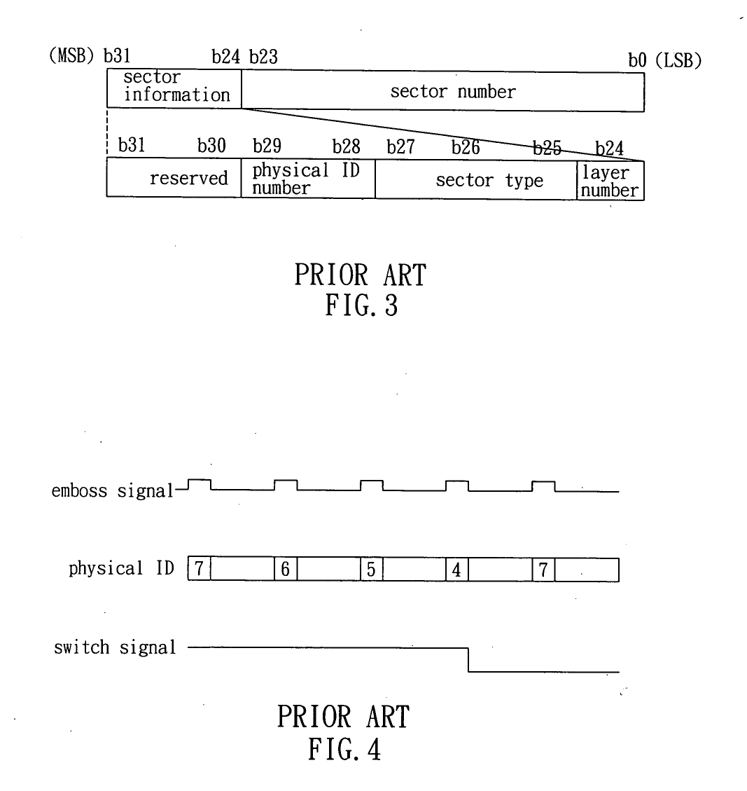

### DETAILED DESCRIPTION OF THE INVENTION

The present invention will be apparent from the following detailed description, which proceeds with reference to the accompanying drawings, wherein the same references relate to the same elements.

A tracking control method according to an embodiment of the invention is used for controlling an optical disk drive to read or write an optical disk, which has a plurality groove tracks and a plurality of land tracks. The groove tracks and the land tracks are alternately interlaced with each other. The tracking control method includes the following steps. Detecting a track position of the optical disk where the optical disk drive accesses. Predicting at least one distance count according to the track position. Generating a switch signal, which controls the optical disk drive to use different accessing powers for accessing the groove tracks and the land tracks, according to the distance count. In the embodiment, the track position is located at a current track of the tracks, and the distance count represents a length between a start point of the current track and a start point of a following track next to the current track.

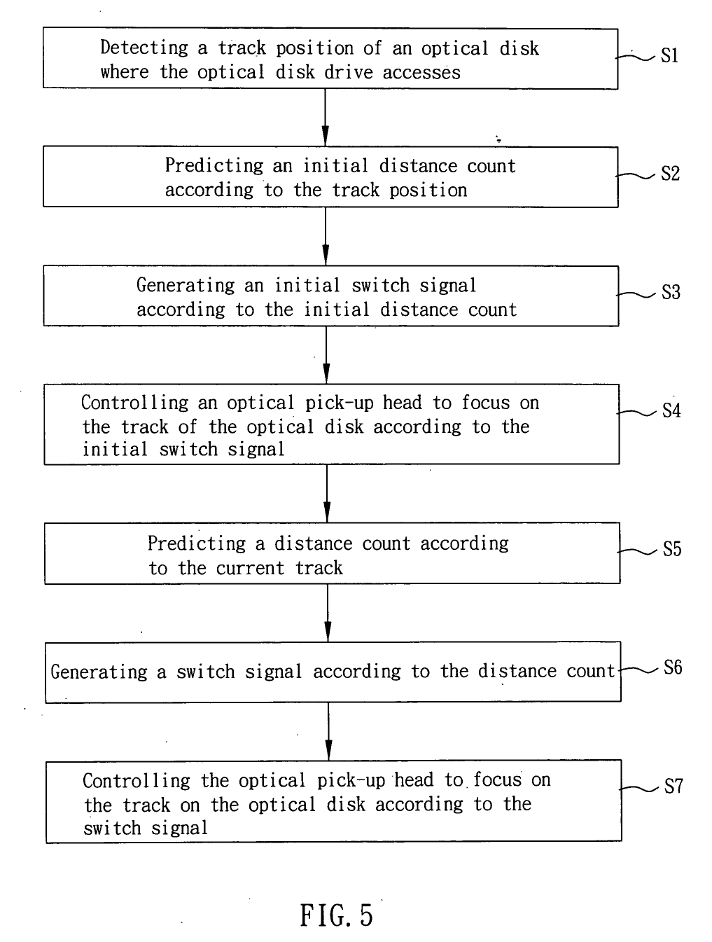

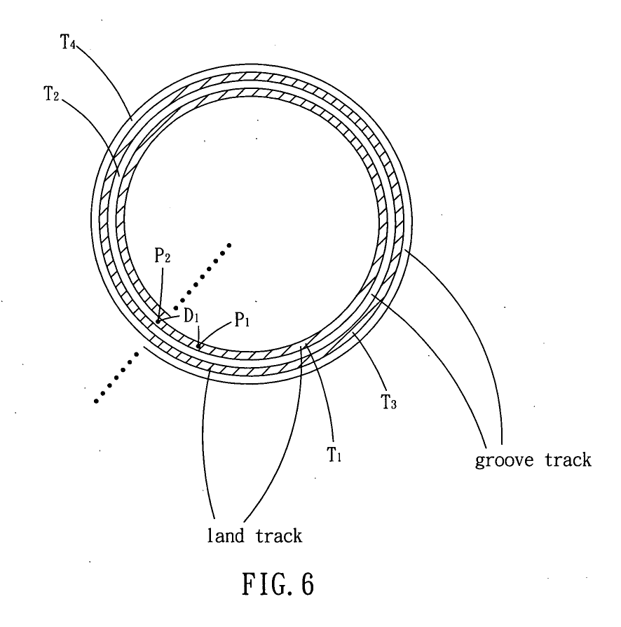

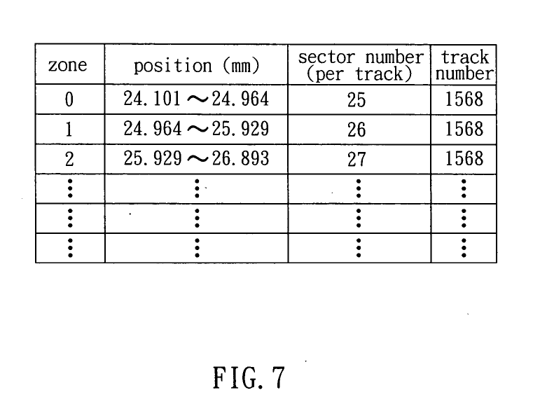

The tracking control method of this embodiment will be described in detail with reference to FIGS. 5 to 7. FIG. 5 is a flow chart showing a tracking control method according to the embodiment of the invention. FIG. 6 is a schematic illustration showing a track structure of an optical disk in the tracking control method according to the embodiment of the invention. FIG. 7 is a schematic illustration showing contents of a groove-land switch table in the tracking control method according to the embodiment of the invention. Referring to FIG. 5, the tracking control method of this embodiment includes steps S1 to S7.

In step S1, detecting a track position P₁ of the optical disk where the optical disk drive accesses (as shown in FIG. 6). Herein, the track position P₁ is located at a current track T₁ of the tracks. In this embodiment, it may detect the track position P₁ of the optical disk where the optical disk drive reads or writes according to a track error (TE) signal of the optical disk drive, or according to a physical ID of the current track T₁ in the step S1. That is, in the step S1, the sector number and the sector type can be found out at the track position P₁ according to the physical ID.

In addition, a groove-land switch table, as shown in FIG. 7, has to be created in advance. Because the optical disk divides the tracks into several zones according to the radius of the track. The tracks in each zone have the same sector number. Thus, it is possible to determine which zone the current track T₁, is located according to the sector number of the track position P₁, and then to find out the number of sectors corresponding to the tracks in this zone according to the groove-land switch table.

In addition, because the zone, the sector number, and the track number of the optical disk have the regularity, a groove-land switch equation can be obtained. Thus, it is also possible to predict the number of sectors in the length from the start point of the current track T₁ to the start point of a following track T₂ next to the current track T₁ according to the groove-land switch equation.

In step S2, predicting an initial distance count according to the track position P₁. In this embodiment, it can determine which zone the current track T₁ is located according to the sector number of the track position P₁, and predict a length D₁ between the track position P₁ and the start point of the following track T₂ according to the groove-land switch table or the groove-land switch equation in the step S2. The distance D₁ is set as the initial distance count. In addition, it may also generate the initial distance count according to the physical ID of the current track T₁ in the step S2.

In step S3, generating an initial switch signal according to the initial distance count. In this embodiment, the initial distance count is decreased each time when the optical disk drive accesses one sector of the current track T₁. For example, the initial distance count is decreased by 1 after one sector of the current track T₁ is accessed. Consequently, when the initial distance count decreases to 0, the optical disk drive generates an initial switch signal. This means that the optical pick-up head has accessed one land-groove switch point, and the optical disk drive switches between different accessing powers to access the groove or land tracks according to the initial switch signal.

For example, when the initial switch signal is at a first level, the optical disk drive switches a first power to access the groove tracks; otherwise, when the initial switch signal is at a second level, the optical disk drive switches a second power to access the land tracks.

In the step S4, controlling an optical pick-up head of the optical disk drive to focus on the track T₂ on the optical disk according to the initial switch signal.

At this time, in the step S5, predicting a distance count, which represents a length between the start point of the current track T₂ and the start point of a following track T₃ next to the current track T₂, according to the current track T₂.

Similarly, the distance count can be obtained by predicting the number of sectors between the start points of the current track T₂ and the following track T₃ according to the groove-land switch table or the groove-land switch equation in this embodiment. The number of sectors represents the distance count.

For example, when the current track T₂ is located at the 1st zone of the optical disk, the track in this zone has 26 sectors by looking up the look-up-table. Then, the distance count is set as 26.

In step S6, generating a switch signal according to the distance count. In this embodiment, the optical disk drive decreases the distance count after accessing one sector of the current track T₂ after the previous land-groove switch point. For example, the distance count is decreased by 1 after one sector of the current track T₂ is accessed. Consequently, when the distance count decreases to 0, the optical disk drive generates a switch signal, which means that the optical pick-up head has accessed one land-groove switch point. Similarly, the optical disk drive switches between different accessing powers to access the groove tracks or the land tracks according to the switch signal.

For example, when the switch signal is at the first level, the optical disk drive switches the first power to access the groove tracks; otherwise, when the switch signal is at the second level, the optical disk drive switches the second power to access the land tracks.

In step S7, controlling an optical pick-up head of the optical disk drive to focus on the track T₃ on the optical disk according to switch signal. At this moment, the procedure goes back to step S5, which predicts the number of sectors between the start points of the current track T₃ and a following track T₄ next to the current track T₃ by looking up the groove-land switch table or using the groove-land switch equation, and re-sets the distance count as the number of sectors.

In step S6, further generating a switch signal according to the distance count. In this embodiment, the optical disk drive decreases the distance count each time when it accesses one sector of the current track T₃after the previous land-groove switch point. For example, the distance count is decreased by 1 each time when one sector of the current track T₃ is accessed. Thus, when the distance count is 0, the optical disk drive generates a switch signal, which means that the optical pick-up head has accessed one land-groove switch point. Similarly, the optical disk drive switches between accessing powers to access the groove tracks or the land tracks according to the switch signal.

In step S7, controlling the optical pick-up head of the optical disk drive to focus on the track T₄ on the optical disk according to switch signal. Then, the procedure goes back to step S5, and the procedures circulate in this manner.

In addition, step S2 may also include a step of determining whether the track position P₁ is located at a start point of the track T₂ according to a track error signal of the optical disk drive. When the track position is located at the start point of the track T₂, the step S3 is directly performed to generate an initial switch signal, which means that the optical pick-up head has accessed one land-groove switch point. Similarly, the optical disk drive switches between different accessing powers to access the groove tracks or the land tracks according to the initial switch signal.

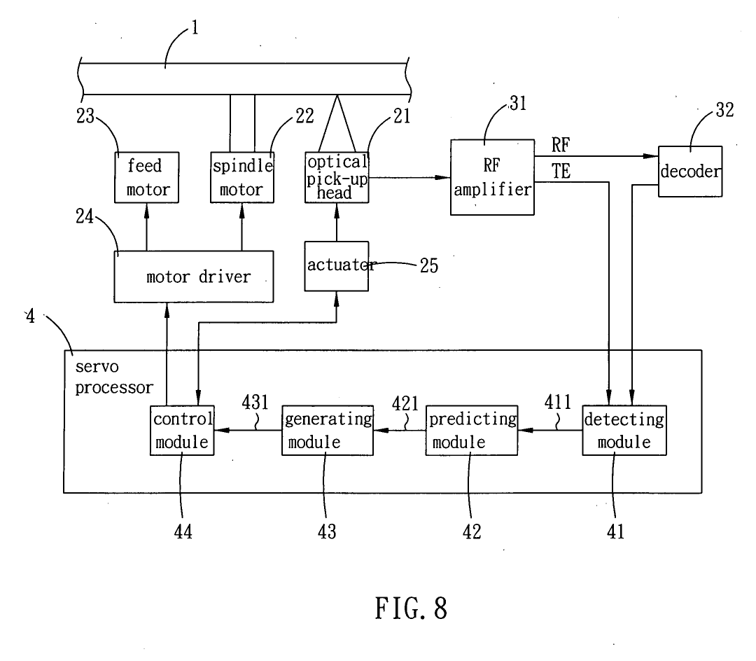

FIG. 8 is a block diagram showing an optical disk drive according to another embodiment of the invention. The tracking control method of the above-mentioned embodiment can be implemented in the optical disk drive of FIG. 8. This optical disk drive includes an optical pick-up head 21, a spindle motor 22, a feed motor 23, a motor driver 24, an actuator 25, a radio frequency amplifier (RF amplifier) 31, a decoder 32 and a servo processor 4. The servo processor 4 includes a detecting module 41, a predicting module 42, a generating module 43 and a control module 44.

The data, which is accessed from the optical disk 1 by the optical pick-up head 21, is amplified by the radio frequency amplifier 31 and then divided into a tracking error signal TE and a radio frequency signal RF. The radio frequency amplifier 31 transfers the tracking error signal TE to the servo processor 4. The detecting module 41 may detect a track position 411 where the optical pick-up head 21 accesses the optical disk 1 according to the tracking error signal TE. The predicting module 42 may predict a distance count 421 by looking up a groove-land switch table according to the track position 411. The contents of the groove-land switch table are shown in FIG. 7 and have to be created in a memory in advance. The predicting module 42 may also predict the distance count 421 by using a groove-land switch equation (not shown) according to the track position 411. The generating module 43 generates a switch signal 431 according to the distance count 421. In this embodiment, each time when the optical disk drive accesses one sector of the current track at which the track position 411 located, the generating module 43 decreases the distance count. For example, each time when one sector of the current track, at which the track position 411 is located, is accessed, the generating module 43 decreases the distance count by 1. When the distance count is 0, the generating module 43 generates a switch signal 431, which means that the optical pick-up head 21 has accessed one land-groove switch point. The control module 44 switches between different accessing powers to access the groove tracks or the land tracks according to the switch signal 431.

For example, when the switch signal 431 is at a first level, the control module 44 switches a first power to access the groove tracks; otherwise, when the switch signal 431 is at a second level, the control module 44 switches a second power to access the land tracks.

In addition, the radio frequency amplifier 31 transfers the radio frequency signal RF to the decoder 32, which decodes the radio frequency signal RF into a physical ID PID and then transfers the physical ID PID to the servo processor 4. The detecting module 41 may detect the track position 411 where the optical pick-up head 21 accesses the optical disk 1 according to the physical ID PID.

The control module 44 may change the ways of controlling the motor driver 24 and the actuator 25 according to the switch signal 431, such that the spindle motor 22, the feed motor 23 and the optical pick-up head 21 work in response to the groove-land property and the optical disk 1 can be correctly accessed.

In this embodiment, the detecting module 41, the predicting module 42, the generating module 43 and the control module 44 may be program codes executed in the servo processor 4. The servo processor 4 may be a controller or a processor. In addition, the radio frequency amplifier 31, the decoder 32 and the servo processor 4 may be integrated on the same chip.

In summary, the tracking control method and the optical disk drive according to the invention detect a track position of the optical disk where the optical disk drive accesses, and then predict at least one distance count according to the track position. Thus, it is possible to prevent the land-groove switch point from being incorrectly determined, such that the optical disk drive can correctly control the optical pick-up head to access the groove tracks or the land tracks.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A tracking control method for controlling an optical disk drive to access an optical disk, wherein the optical disk has a plurality of groove tracks and a plurality of land tracks, and the groove tracks and the land tracks are alternately interlaced with each other, the method comprising the steps of:
detecting a track position of the optical disk where the optical disk drive accesses, wherein the track position is located at a current track;
predicting at least one distance count according to the track position of the current track, wherein the distance count represents a length between a start point of the current track and a start point of a following track next to the current track; and
generating a switch signal according to the distance count, wherein the switch signal controls the optical disk drive to use different accessing powers for accessing the groove tracks and the land tracks.

2. The tracking control method according to claim 1, further comprising the step of:
controlling an optical pick-up head of the optical disk drive to focus on the following track of the optical disk according to the switch signal.

3. The tracking control method according to claim 1, wherein when the switch signal is at a first level, the optical disk drive switches to use a first power to access the groove tracks, and when the switch signal is at a second level, the optical disk drive switches to use a second power to access the land tracks.

4. The tracking control method according to claim 1, wherein the step of generating the switch signal according to the distance count is to decrease the distance count each time when a sector of the current track is accessed, and to generate the switch signal when the distance count decreases to 0.

5. The tracking control method according to claim 1, wherein the step of predicting the distance count according to the track position is to predict the distance count according to information of zones, a sector number and a track number of the optical disk.

6. The tracking control method according to claim 1, further comprising the steps of:
predicting at least one initial distance count according to the track position, wherein the initial distance count represents a length between the track position and a start point of the following track; and
generating an initial switch signal according to the initial distance count, wherein the initial switch signal controls the optical disk drive to use different accessing powers for accessing the groove tracks and the land tracks.

7. The tracking control method according to claim 6, wherein the initial distance count is predicted according to information of zones, a sector number and a track number of the optical disk.

8. The tracking control method according to claim 7, wherein when the initial switch signal is at a first level, the optical disk drive switches to use a first power to access the groove tracks, and when the initial switch signal is at a second level, the optical disk drive switches to use a second power to access the land tracks.

9. The tracking control method according to claim 1, further comprising the steps of:
determining whether the track position is located at the start point of the following track according to a track error signal of the optical disk drive; and
when the track position is located at the start point of the following track, generating an initial switch signal for controlling the optical disk drive to use different accessing powers for accessing the groove tracks and the land tracks.

10. An optical disk drive for accessing an optical disk having a plurality of groove tracks and a plurality of land tracks, wherein the groove tracks and the land tracks are alternately interlaced with each other, the optical disk drive comprising:
a detecting module for detecting a track position of the optical disk where the optical disk drive accesses, wherein the track position is located at a current track;
a predicting module for predicting a distance count according to the track position of the current track, wherein the distance count represents a length between a start point of the current track and a start point of a following track next to the current track; and
a generating module for generating a switch signal according to the distance count, wherein the switch signal controls the optical disk drive to use different accessing powers for accessing the groove tracks and the land tracks.

11. The optical disk drive according to claim 10, further comprising:
a control module for controlling an optical pick-up head of the optical disk drive to focus on one of the groove tracks and the land tracks of the optical disk according to the switch signal.

12. The optical disk drive according to claim 10, wherein when the switch signal is at a first level, the optical disk drive switches to use a first power to access the groove tracks, and when the switch signal is at a second level, the optical disk drive switches to use a second power to access the land tracks.

13. The optical disk drive according to claim 10, wherein the predicting module decreases the distance count each time when a sector of the current track is accessed, and the generating module generates the switch signal when the distance count decreases to 0.

14. The optical disk drive according to claim 10, wherein the predicting module predicts the distance count according to information of zones, a sector number and a track number of the optical disk.

15. The optical disk drive according to claim 10, wherein the predicting module further predicts at least one initial distance count according to the track position, the generating module further generates an initial switch signal according to the initial distance count, the initial distance count represents a length between the track position and a start point of the following track, and the initial switch signal controls the optical disk drive to use different accessing powers for accessing the groove tracks and the land tracks.

16. The optical disk drive according to claim 15, wherein when the initial switch signal is at a first level, the optical disk drive switches to use a first power to access the groove tracks, and when the initial switch signal is at a second level, the optical disk drive switches to use a second power to access the land tracks.

17. The optical disk drive according to claim 10, wherein the predicting module further determines whether the track position is located at the start point of the following track according to a track error signal of the optical disk drive, and when the track position is located at the start point of the following track, the generating module generates an initial switch signal for controlling the optical disk drive to use different accessing powers for accessing the groove tracks and the land tracks.
